(19) United States
(12) Patent Application Publication
(10) Pub. No.: US 2017/0028647 A1
(43) Pub. Date: Feb. 2, 2017

(54) THREE DIMENSIONAL PRINTING SYSTEM

(71) Applicant: Industrial Technology Research Institute, Hsinchu (TW)

(72) Inventors: Chia-Hsin Chao, Hsinchu County (TW); Yen-Hsiang Fang, New Taipei City (TW); Ming-Hsien Wu, Tainan City (TW); Ying-Chien Chu, Tainan City (TW)

(21) Appl. No.: 14/979,585

(22) Filed: Dec. 28, 2015

Related U.S. Application Data
(60) Provisional application No. 62/198,645, filed on Jul. 29, 2015.

(30) Foreign Application Priority Data
Dec. 3, 2015 (TW) 104140607

(51) Int. Cl. B29C 67/00

(52) U.S. Cl. CPC B29C 67/0088; B29C 67/0066; B29K 2105/0058

(57) ABSTRACT

In one exemplary embodiment, a three dimensional printing system may include a tank filled with liquid forming material, a carrier platform, an optical module disposed under the tank, and a control module is provided. The control module is electrically connected to the optical module and the carrier platform, such that the carrier platform is controlled to move in the tank, and the optical module is controlled to generate light irradiating to the liquid forming material to form a solidification layer on the carrier platform. An image position of the optical module is located in a specific position away from the bottom of the tank in the liquid forming material to form a solidification plane, the liquid forming material at the solidification plane is cured and solidified to form the solidification layer, and a plurality of solidification layers are stacked to form a three dimensional object.

### CROSS-REFERENCE TO RELATED APPLICATION

This application claims the priority benefits of U.S. provisional application Ser. No. 62/198,645, filed on Jul. 29, 2015 and Taiwan application serial no. 104140607, filed on Dec. 3, 2015. The entirety of the above-mentioned patent application is hereby incorporated by reference herein and made a part of this specification.

### BACKGROUND

Technical Field

The disclosure relates to a three dimensional printing system.

Background

With advancement in technology and evolution of manufacturing technique, manufacturing time and precision for workpieces are continuously improved. The three dimensional printing technology not only may provide rapid model molding, but also may directly provide finished or semi-finished products with sufficient precision.

Generally, additive manufacturing technology transforms design data of a 3D module constructed by a computer aided design (CAD) software into a plurality of consecutively stacked thin (quasi-two-dimensional) cross-sectional layers. Meanwhile, many techniques for forming a plurality of thin cross-sectional layers have also gradually been proposed. For instance, a printing module of a printing device can move above a base of the tank along the XY plane according to spatial coordinates XYZ constructed with the design data of the 3D model, so as to enable a construction material to form a cross-sectional layer with accurate shape. The deposited construction material may then be naturally hardened or be cured via heat or light source irradiation, so as to be formed into the required cross-sectional layer. By having the printing module to move layer-by-layer along the Z-axis, the plurality of cross-sectional layers may be stacked layer-by-layer along the Z-axis so as to enable the construction material to form a three dimensional structure in a layer-by-layer curing manner.

Three dimensional printing technologies may include Selective Laser Sintering (SLS), Three-Dimensional Printing (3DP), Laminated Object Manufacturing (LOM), Fused Deposition Modeling (FDM) of the current mainstream, and the newest Digital Light Processing (DLP) have been developed and put into production.

Taking the DLP technology for an example, it uses layers of light irradiation to cure a liquid forming material into different patterns for being stacked layer-by-layer into a three dimensional object. The process for each layer may include light curing a single layer on a carrier board, stripping the solidification layer off the carrier board, and resetting carrier board and dispensing the liquid forming material to perform the curing of the next layer. In order to one-by-one perform the aforesaid process steps repeatedly, the carrier board is being controlled to cooperate with the light solidified layer in a mechanical actuation procedure, and this, may causes a prolonged processing time in the DLP process, thereby resulting in a low efficiency of the DLP process. Hence, how to reduce the processing time of the process or improve the step configuration requiring to be performed one-by-one is in need of further research and development by those skilled in the art.

### SUMMARY

In one of exemplary embodiments, the three dimensional printing system may include a tank, a carrier platform, an optical module and a control module. The tank is filled with liquid forming material. The carrier platform is movably disposed in the tank. The optical module is disposed under the tank. The control module is electrically connected to the carrier platform and the optical module. The control module controls the optical module to generate light passing through the bottom of the tank and irradiating to the liquid forming material in the tank to form a solidification layer on the carrier platform, and as the control module drives the carrier platform to continuously move away from the optical module, a plurality of solidification layers are stacked on the carrier platform to form a three dimensional object. The optical module is driven by the control module to generate light irradiating to the liquid forming material. An image position of the optical module forms a solidification plane at a specific position in the liquid forming material away from the bottom of the tank, and the liquid forming material at the solidification plane is stacked to form the solidification layer.

In one of exemplary embodiments, the three dimensional printing system may include a tank, a carrier platform and an optical module. The tank is filled with liquid forming material. The carrier platform is movably disposed in the tank. The optical module is disposed under the tank. The optical module generates light passing through the bottom of the tank and irradiating to the liquid forming material in the tank, an image position of the optical module forms a solidification plane in the liquid forming material, the liquid forming material at the solidification plane is cured to form a solidification layer on the carrier platform, and as the control module drives the carrier platform to continuously move away from the optical module, a plurality of solidification layers are stacked on the carrier platform to form a three dimensional object. An absorbed photon dosage D(z) of each solidification plane is: D(z)=[S(z, θ)+S′(z, θ)]Φ₀te^{-αz}, wherein S(z, θ) is a size of a light spot formed by the optical module at the image position, S(z, θ)=1/[S₀+2(f−z)tan θ]², Φ₀ is a photon flux when the light incidents to the bottom of the tank, θ is an incident angle of the light, z is a distance to the bottom of the tank, t is a time, α is a material absorption coefficient of the liquid forming material, and S′(z, θ)=(2 tan θ)/[S₀+2(f−z)tan θ]³, wherein f is a distance from the solidification plane to the bottom of the tank, S₀ is a size of the light spot when light incidents to the bottom of the tank, and D(f−Δf)−D(Δf)≧0, f>2Δf, wherein a thickness of the solidification layer is 2Δf.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram illustrating a three dimensional printing system according to one embodiment of the invention.

FIG. 2 is a schematic diagram illustrating the three dimensional printing system of FIG. 1 forming a three dimensional object.

FIG. 3 illustrates a partial enlarged diagram of a light source and a lens in FIG. 1 and FIG. 2.

FIG. 4 and FIG. 5 are schematic diagrams respectively illustrating absorbed photon dosages under different conditions.

FIG. 6 is a schematic diagram illustrating the absorbed photon dosage of the three dimensional printing system in another state.

### DETAILED DESCRIPTION OF DISCLOSED EMBODIMENTS

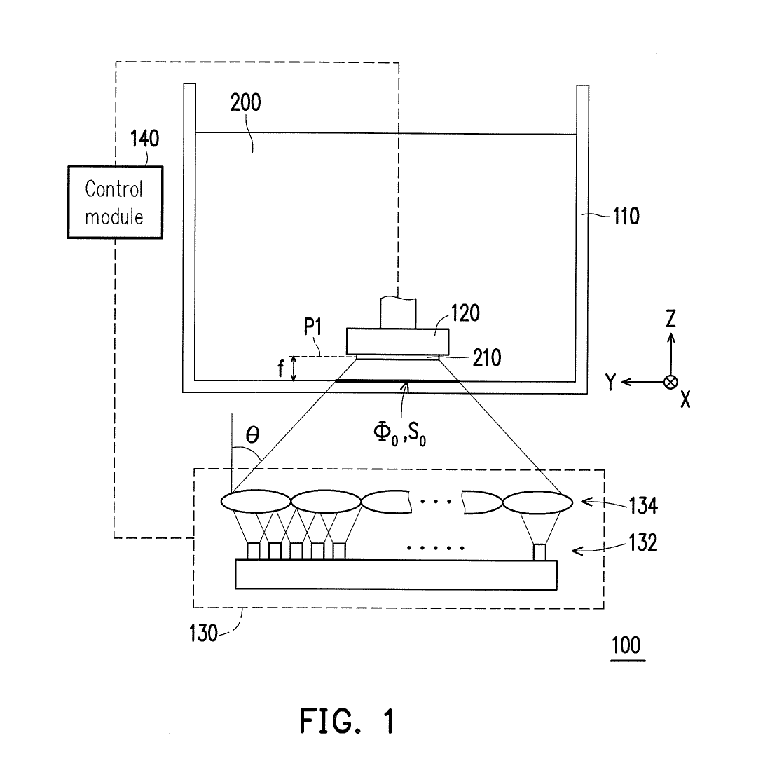

FIG. 1 is a schematic diagram illustrating a three dimensional printing system according to one embodiment of the invention. FIG. 2 is a schematic diagram illustrating the three dimensional printing system of FIG. 1 forming a three dimensional object. Referring to FIG. 1 and FIG. 2, in the present embodiment, a three dimensional printing system 100 may include a tank 110, a carrier platform 120, an optical module 130 and a control module 140, wherein the tank 110 is filled with a liquid forming material 200, the carrier platform 120 and the optical module 130 are respectively electrically connected to the control module 140 so as to be controlled to perform related actions. The carrier platform 120 is being controlled to move in the tank 110, while the optical module 130 is disposed under the tank 110 and controlled to generate light, which passes through the bottom of the tank 110 and irradiates to the liquid forming material 200 in the tank 110.

Furthermore, the carrier platform 120 is controlled by the control module 140 to be movably disposed in the tank 110 along a Z-axis, such that the carrier platform 120 may move out of the tank 110 or move into the tank 110 and be immersed in the liquid forming material 200. The light provided by the optical module 130 may be irradiated to the liquid forming material 200 at the carrier platform 120 so as to form and stack a plurality of solidification layers 210 on the carrier platform 120. As the control module 140 drives the carrier platform 120 to move, such as enabling the carrier platform 120 to move away from the optical module 130 along the Z-axis (e.g., positive Z-axis direction), the solidification layers 210 are stacked on the carrier platform 120 to form a three dimensional object 220.

The liquid forming material 200 is, for example, photosensitive resin, and the optical module 130 is configured to provide light in a bandwidth capable of curing the photosensitive resin (e.g., UV light). By having the light provided by the optical module 130 to pass through the tank 110 and scanningly irradiating to the liquid forming material 200 between the carrier platform 120 and the bottom of the tank 110, the liquid forming material 200 may be cured layer-by-layer and stacked on the carrier platform 120, and the three dimensional object 220 can be formed on the carrier platform 120 as the carrier platform 120 (along the positive Z-axis direction) moves away from the bottom of the tank 110 (namely, the three dimensional object 220 is being formed towards the negative Z-axis direction).

Herein, an image position P1 of the light generated by the optical module 130 may be controlled by the control module 140 to fall on a specific position in the liquid forming material 200 that is away from the bottom of the tank 110, so that the image position P1 of the optical module 130 may form a solidification plane in the liquid forming material 200 and enable the liquid forming material 200 at the solidification plane to be cured to form the solidification layer 210. In detail, the optical module 130 may include at least one light source 132 and at least one lens 134; further, the light source 132 of the present embodiment may include a micro-light-emitting diode (μLED) or a μLED array, wherein the μLED array is referred to light emitting pixels of a display device. For instance, in a display with Full HD resolution, the number of μLED array is 1920×1080. The lens 134 of the present embodiment may include a micro-lens or an array of micro-lenses, wherein the lens 134 is located between the light source 132 and the tank 110 to enable the light generated by the light source 132 to incident into the tank 110 through the lens 134 with an incident angle θ, the image position P1 of the optical module 130 is focused at a specific position in the liquid forming material 200 away from the bottom of the tank 110 to form the solidification plane, and the liquid forming material 200 at the solidification plane to be cured into the solidification layer 210. The carrier platform 120 may be driven to move continuously towards the positive Z-axis direction so as to stack a plurality of solidification layers 210.

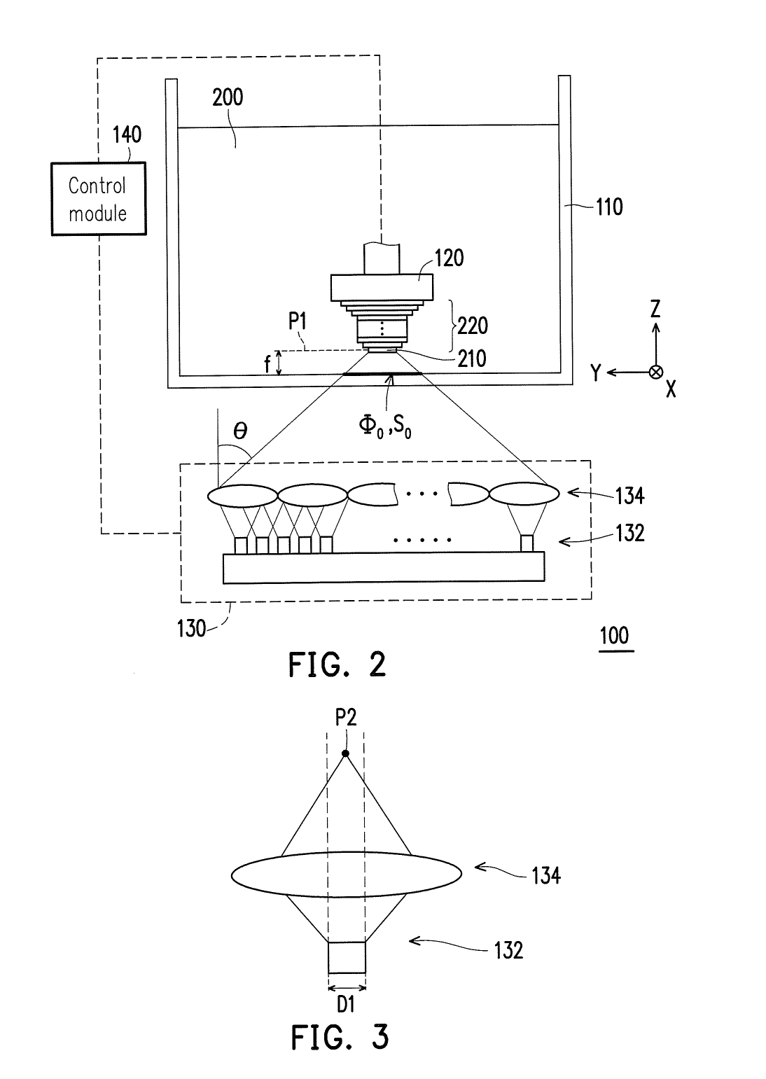

FIG. 3 illustrates a partial enlarged diagram of a light source and a lens in FIG. 1 and FIG. 2, whereby the light path of one light source 132 and one lens 134 is being illustrated herein for reference. Referring to FIG. 3, in the present embodiment, with coordination of the lens 134, the light after passing through the lens 134 may be converged at a large angle, the optical module 130 may form a light spot P2 at the image position P1 and a size of the light spot P2 is smaller than a size of a light emitting area D1 of the light source 132 (namely, the size of P2 is smaller than the size of D1). Hence, the contrast between the cured and non-cured material interfaces may be enhanced, thereby enabling a surface of the molded object to be smoother, such as enabling the three dimensional object 220 to have a higher resolution and fine appearance after being cured and formed. In another embodiment (not shown), the aforesaid μLED array may also be attached onto a imaging lens via an optical tube, or become one of a plurality of lenses of the imaging lens, so as to be integrated into a single (integrated) lens group.

On the other hand, as shown in FIG. 1, whether the liquid forming material 200 is to be cured may be depended on the amount of photons received per unit area (or unit volume) within a period of time, that is, when the light irradiates to the liquid forming material 200, a photon density at certain region in the liquid forming material 200 be above a certain value in order to cure liquid forming material 200. It can be known from FIG. 1, on a path in which the light generated by the optical module 130 passes through the liquid forming material 200 in the tank 110, with the coordination between the light source 132 and the lens 134, the photon density at the image position P1 reaches a amount of photon for the liquid forming material 200 at the image position P1 to be cured to from the solidification plane.

Herein, Cartesian coordinate system is provided for facilitating the understanding of the subsequent descriptions, and the bottom of the tank 110 is set at a X-Y plane (i.e., at where Z=0). Hence, in the present embodiment, according to Beer-Lambert law, photons produces different distribution states based on different depths into the tank 110 (i.e., distance z from the bottom of the tank 110), and a distribution function thereof is: Φ(z)=Φ₀S(z, θ)e^{-αz}, wherein Φ₀ is a photon flux when the light incidents to the bottom of the tank 110 (i.e., at z=0, and on the X-Y plane), θ is an incident angle of the light, α is a material absorption coefficient of the liquid forming material 200, and S(z, θ) represents a size of a light spot after the light incidents to the liquid forming material 200, which is a function of the incident angle θ and the distance z. As such, S(z, θ)=1/[S₀+2(f−z)tan θ]², wherein f is a distance from the solidification plane to the bottom of the tank 110, S₀ is a size of the light spot when the light incidents to the bottom of the tank 110 (i.e., at z=0). It can be known from FIG. 1 that, as the incident angle θ becomes larger, the size of the light spot decreases with the distance z, and thus, which also indicates that, the photon density becomes greater (i.e., it increases with the distance z). Therefore, by taking a derivative of the distance z and multiply by a time t of light irradiation, an absorbed photon dosage per unit depth D(z) is obtained, that is:

D(z)=[S(z,θ)+S′(z,θ)]Φ₀te^{-αz},

wherein S′(z, θ)=(2 tan θ)/[S₀+2(f−z)tan θ]³.

As such, it can be determined that whether the liquid forming material 200 at a specific position (with the distance z) is cured.

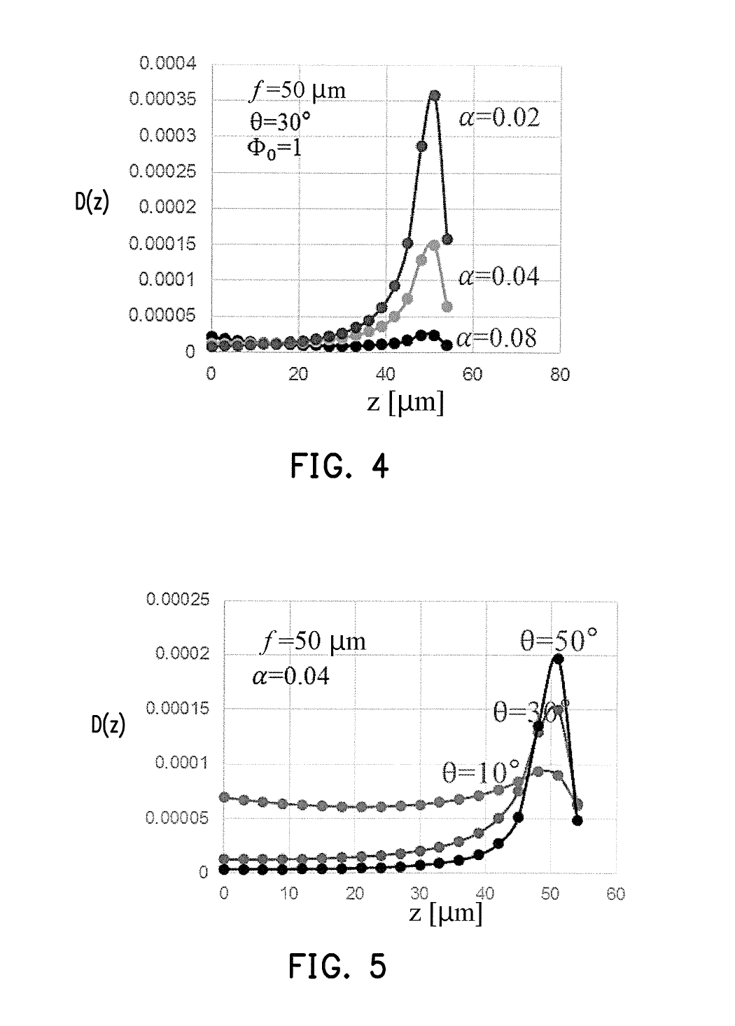

FIG. 4 and FIG. 5 are schematic diagrams respectively illustrating absorbed photon dosages under different conditions. Referring to FIG. 4, which illustrates the corresponding absorbed photon dosage per unit depth D(z) of various of liquid forming materials 200 under a condition when f=50 μm, the incident angle θ=30° and the photon flux Φ₀=1 (which is normalized to serve as a reference variable)(herein, different material absorption coefficients α are used as segmentations and representations, and also represent different types of liquid forming material 200 corresponded by different wavelengths of lights generated by the optical module 130). It can be known from FIG. 4 that, by choosing the liquid forming material 200 with lower material absorption coefficient α (for instance, the material absorption coefficient α≦0.04), an effect of curing the liquid forming material 200 at the specific position may be achieved. As shown in FIG. 5, which illustrates the absorbed photon dosage per unit depth D(z) corresponded by the optical module 130 with different incident angles θ under a condition when f=50 μm and the material absorption coefficient α=0.04, it can be known that, by using the larger incident angle (for instance, the incident angle θ≧30°), an effect of curing the liquid forming material 200 at the specific position may be achieved.

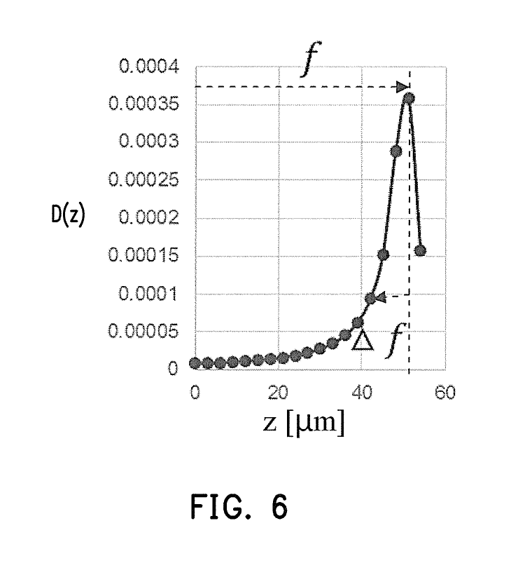

FIG. 6 is a schematic diagram illustrating the absorbed photon dosage of the three dimensional printing system in another state. Referring to FIG. 6, may cure the liquid forming material 200 at the specific position between the carrier platform 120 and the bottom of the tank 110, the aforesaid absorbed photon dosage D(z) further requires to satisfy:

D(f−Δf)−D(Δf)≧0.

The absorbed photon dosage at a position (f−Δf) may exceed a threshold required for curing, and a thickness of the solidification layer 210 is approximately 2Δf such that f>2Δf. The thickness 2Δf of the solidification layer 210 may be decided by adjusting the incident angle θ and the material absorption coefficient α, that is, a thickness of which the liquid forming material 200 may be instantly cured, wherein under such a condition, the distance f from the solidification plane to the bottom of the tank 110, the incident angle θ and the material absorption coefficient α may set (for instance, f=50 μm, θ=30° and α=0.02). In other words, at this point, liquid forming material 200 at the solidification plane (i.e., at f=50 μm) is cured into the solidification layer 210, and the liquid forming material 200 from the bottom of the tank 110 (i.e., at z=0, and on the X-Y plane) to the position of (f−Δf) remains as liquid, thereby enabling the three dimensional printing system 100 to achieve an effect of remote curing. In further terms, the liquid forming material 200 on the irradiation path of the light (i.e., from z=0 to (f−Δf)) is able to maintain liquid state due to insufficient photon density. Referring to FIG. 1 again, before the first solidification layer 210 is formed, there is a gap existed between the carrier platform 120 and the bottom of the tank 110, and the gap is greater than the thickness of the solidification layer 210.

Moreover, in another exemplary embodiment, the light source 132 (i.e., the aforesaid the μLEDs or the μLED array), with specific arrangement, may generate light with a specific pattern so that the image position P1 of the optical module 130 may have the specific pattern, and thereby forms a solidification plane with the specific pattern in the liquid forming material 200. As such, the liquid forming material 200 may be cured into a solidification layer 210 with a specific pattern, and the three dimensional object 220 is formed layer-by-layer by stacking a plurality of patterned solidification layers 210 gradually. Similarly, the optical module 130 may also use optical elements (e.g., light guide element or shielding element) to enable the light source 132 to generate light with the specific pattern.

In the exemplary embodiments of the disclosure, by using the optical module to enable the liquid forming material at the specific location between the carrier platform and the bottom of the tank to be cured, a moving time of the carrier platform is reduced, and thus a reflux waiting time for surrounding the liquid forming material is also reduced. In other words, with the optical module enables the liquid forming material in the tank to achieve the effect of remote curing. That is, the three dimensional printing system may adjust the image position in the liquid forming material because of the optical module (i.e., the image position of the optical module may move along the Z-axis to a position required for the solidification plane to be formed in the liquid forming material), and may decrease a processing time for driving the carrier platform and improve a process efficiency.

It will be clear that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A three dimensional printing system, comprising:
a tank, filled with a liquid forming material;
a carrier platform, movably disposed in the tank;
an optical module, disposed under tank; and
a control module, electrically connected to the carrier platform and the optical module, wherein the control module controls the optical module to generate light passing through the bottom of the tank and irradiating the liquid forming material in the tank to form a solidification layer on the carrier platform, and as the control module drives the carrier platform to continuously move away from the optical module, a plurality of solidification layers are stacked on the carrier platform to form a three dimensional object, wherein the optical module is driven by the control module to generate light irradiating to the liquid forming material and an image position of the optical module forms a solidification plane at a specific position in the liquid forming material away from the bottom of the tank, and the liquid forming material at the solidification plane is stacked to form the solidification layer.

2. The three dimensional printing system as recited in claim 1, wherein when a first solidification layer is formed, a gap is existed between the carrier platform and the bottom of the tank.

3. The three dimensional printing system as recited in claim 2, wherein the gap is greater than a thickness of the first solidification layer.

4. The three dimensional printing system as recited in claim 1, wherein the optical module comprises:
at least one light source; and
at least one lens, disposed corresponding to a position of the light source, so as to focus light generated by the light source at the image position and to form the solidification plane in the liquid forming material.

5. The three dimensional printing system as recited in claim 4, wherein the light source comprises a micro-light-emitting diode or an array of micro-light-emitting diodes.

6. The three dimensional printing system as recited in claim 4, wherein the lens comprises a micro-lens or an array of micro-lenses.

7. The three dimensional printing system as recited in claim 4, wherein the optical module comprises a plurality of light sources and a plurality of lenses, light generated by each of the light sources forms a light spot at the image position through the lenses, and a size of the light spots is smaller than a size of the light sources.

8. The three dimensional printing system as recited in claim 1, wherein an absorbed photon dosage D(z) of the liquid forming material to the light generated by the optical module on the solidification plane is: D(z)=[S(z, θ)+S′(z, θ)]Φ₀te^{-αz}, wherein S(z, θ) is a size of a light spot formed by the optical module at the image position, S(z, θ)=1/[S₀+2(f−z)tan θ]², Φ₀ is a photon flux when the light incidents to the bottom of the tank, θ is an incident angle of the light, z is a distance to the bottom of the tank, t is a time, α is a material absorption coefficient of the liquid forming material, and S′(z, θ)=(2 tan θ)/[S₀+2(f−z)tan θ]³, wherein f is a distance from the solidification plane to the bottom of the tank, S₀ is a size of the light spot when the light incidents to the bottom of the tank, and D(f−Δf)−D(Δf)≧0, f>2Δf, wherein a thickness of the solidification layer is 2Δf.

9. The three dimensional printing system as recited in claim 8, wherein α≦0.15 μm-1, θ>10°.

10. The three dimensional printing system as recited in claim 8, wherein α≦0.05 μm-1, θ>30°.

11. A three dimensional printing system, comprising:
a tank, filled with a liquid forming material;
a carrier platform, movably disposed in the tank; and
an optical module, disposed under the tank, wherein the optical module generates light passing through the bottom of the tank and irradiating to the liquid forming material in the tank, an image position of the optical module forms a solidification plane in the liquid forming material, the liquid forming material at the solidification plane is cured to form a solidification layer on the carrier platform, and as the control module drives the carrier platform to continuously move away from the optical module, a plurality of solidification layers are stacked on the carrier platform to form a three dimensional object, and an absorbed photon dosage D(z) of each solidification plane is: D(z)=[S(z, θ)+S′(z, θ)]Φ₀te^{-αz}, wherein S(z, θ) is a size of a light spot formed by the optical module at the image position, S(z, θ)=1/[S₀+2(f−z)tan θ]², Φ₀ is a photon flux when the light incidents to the bottom of the tank, θ is an incident angle of the light, z is a distance to the bottom of the tank, t is a time, α is a material absorption coefficient of the liquid forming material, and S′(z, θ)=(2 tan θ)/[S₀+2(f−z)tan θ]³, wherein f is a distance from the solidification plane to the bottom of the tank, S₀ is a size of the light spot when light incidents to the bottom of the tank, and D(f−Δf)−D(Δf)≧0, f>2Δf, wherein a thickness of the solidification layer is 2Δf.
